(19) United States
(12) Patent Application Publication
(10) Pub. No.: US 2006/0077253 A1
(43) Pub. Date: Apr. 13, 2006

(54) System and method for enhanced situation awareness

(75) Inventors: Ryan A. VanRiper, Maple Lake, MN (US); Thomas Anderson Wagner, Vienna, VA (US); John A. Phelps, Newport, ME (US)

Correspondence Address: Paul M. Vargo;Honeywell International, Inc., 22nd Floor, 120 South Riverside Plaza, Chicago, IL, 60606, US

(73) Assignee: Honeywell International, Inc., Morristown, NJ (US)

(21) Appl. No.: 10/964,282

(22) Filed: Oct. 13, 2004

(51) Int. Cl. H04N 7/18; H04N 9/47

(52) U.S. Cl. 348/143

(57) ABSTRACT

A system and a method identify the presence and actions of first responders in a region. Receivers can respond to radio frequency identifying tags affixed to people or building assets in the region. One of a plurality of regional cameras can be selected, based on at least one responding receiver, to provide at least one visual display.

### FIELD OF THE INVENTION

The invention pertains to emergency related situational information systems and methods. Emergencies can include fires, hazardous material situations, accidents or the like. More particularly, the invention pertains to systems and methods that provide real-time feedback to situation responders as to locations and activities of personnel in a region of interest.

### BACKGROUND OF THE INVENTION

When first responders arrive at the location of an incident, the circumstances or dangers to those persons already in the area or region are often unclear. Local responders have to make decisions based on incomplete, sometimes erroneous information. The responders may have to send their personnel into such regions to try to rescue people, often exposing themselves to dangerous circumstances.

Communications between the emergency personnel in the region and outside of the region are often tenuous at best. There is a continuing need for systems and methods which might assist responders or other supervisory personnel in tracking the location and movement of emergency personnel in the region. Preferably, such systems and methods will not impose any operational burdens on the personnel in the region. It would also be desirable to be able to install and use such systems and methods in regions which might already have operating fire detection systems or the like.

### BRIEF DESCRIPTION OF THE DRAWINGS

FIG. 1 is a plan view of a portion of a monitorable region in accordance with the invention; and

FIG. 2 is a block diagram of a portion of a monitoring system in accordance with the invention.

### DETAILED DESCRIPTION OF THE EMBODIMENTS

While embodiments of this invention can take many different forms, specific embodiments thereof are shown in the drawings and will be described herein in detail with the understanding that the present disclosure is to be considered as an exemplification of the principles of the invention and is not intended to limit the invention to the specific embodiment illustrated.

Systems and methods which embody the invention enhance situation awareness of local responders by using live camera feeds, floor plan maps, radio frequency identification (RFID) tags and sensors. With both live camera feeds and RFID tag feedback available more information can be provided to local responders in real-time.

Displayable pre-stored maps or plans of the regions of interest can include camera and tag sensor locations. When a tag is sensed, the appropriate floor plan or region can be presented and a respective camera can be selected. Camera feed can be presented on or adjacent to the floor plan or regional display. First Responders thus have a live view of the situation and can ascertain which and how many personnel are in the displayed portion of the floor or region.

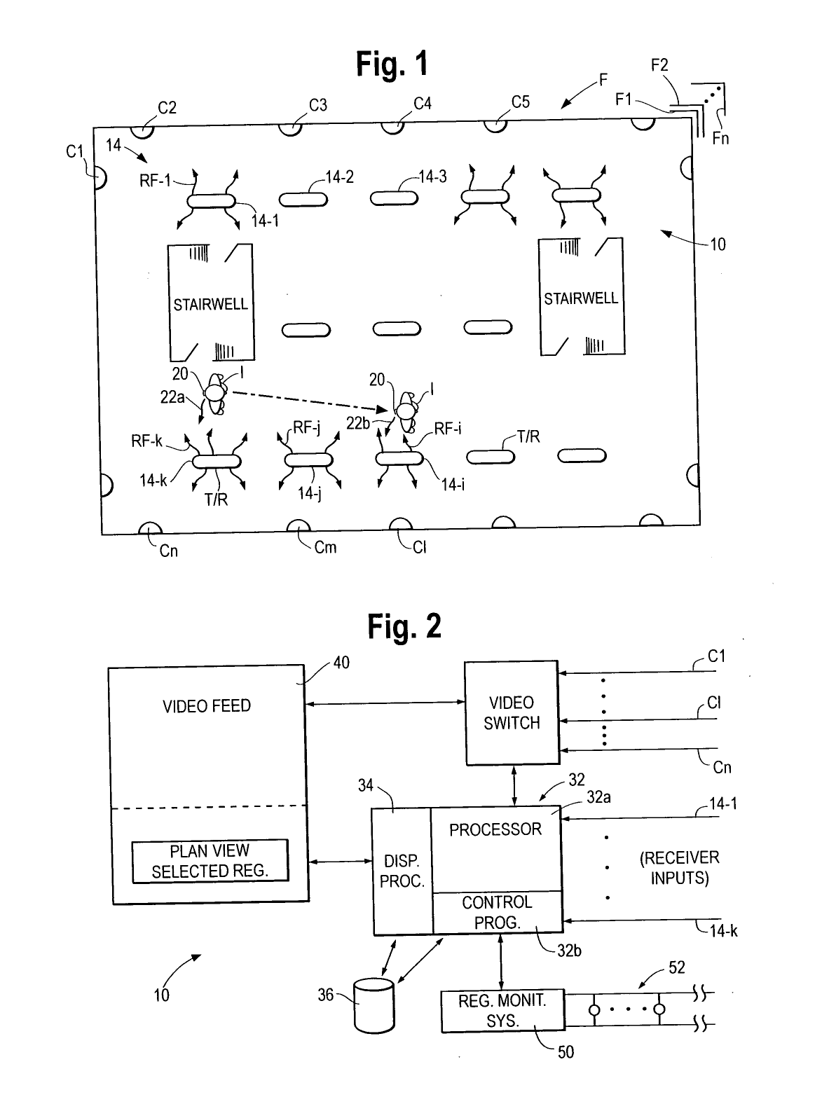

FIG. 1 is an exemplary plan view of a floor or a portion F of a building or region being monitored. It will be understood that corresponding representations of other floors, F1, F2 . . . Fn could also be illustrated in accordance with the invention.

Portions of a monitoring system 10 are installed on the floor F. These include a plurality of video cameras, C1, C2 . . . Cn scattered about the floor F in any convenient fashion depending on the configuration thereof. The cameras C1 . . . Cn provide real time images of various aspects of the floor F, as discussed in more detail subsequently.

System 10 also includes a plurality of radio frequency transmitter/receiver 14 such as 14-1, 14-2 . . . 14-k. The transmitter/receiver units 14 are part of a radio frequency identification system which can be used with active or passive RFID tags of known types. As those of skill in the art will appreciate, the selected RFID tags can be used in combination with the transmitter/receiver 14 to provide location information as to first responders or other emergency personnel on the floor F.

The responders or emergency personnel, such as individual I, can each be equipped with an RFID tag, illustrated generally at 20. The tag 20 can be carried anywhere on the individual's uniform, helmet or other equipment as is convenient. When a tag, such as a tag 20 receives incident RF, such as RF signals RF-k from transmitter/receiver unit 14-k, reply signals such as 22a, 22b can be transmitted by the respective tag and sensed by the receiver of the respective transmitter/receiver unit. Hence, as the individual I moves about the floor F, his/her location can be continuously tracked in real time.

FIG. 2 is a block diagram of various components of system 10. These include a video switch 30 which is coupled to each of the cameras, C1, C2 . . . Cn on the floor F. The switch 30 is coupled to a control system 32 which could include a programmed processor 32a and an associated control program 32b. The processor 32 could be in communication with a display processor 34 coupled to a display 40, as well as a database 36.

Video switch 30 is also coupled to a display unit 40. The video switch 30 can select video feed from one or more of the cameras such as C1, C2 . . . Cn and couple same to the display unit 40 to provide real time images in the region F from the selected camera. It will be understood that the details of the display unit 40 are not limitations of the present invention.

System 10 also receives signals from the plurality of receivers 14-1 . . . -k which feed back location information relative to the active RFID tags in the region being monitored, such as the tag 20. In response thereto, processor 32 can select a floor plan(s) such as F, F1 . . . Fn from database 36, which might correspond to the plan view of the floor plan F in FIG. 1, and present same on a portion or all of the display unit 40.

It will be understood that the exact representation of the display on the unit 40 is not a limitation of the present invention. Alternate graphical presentations come within the spirit and scope of the present invention. For example, one portion of the display 40 can present a top plan view of the region such as F associated with feed back being received from the respective receiver, such as 14-i by processor 32. In this instance, the processor 32 can present the respective floor plan, floor plan F for example, on a portion of the display 40. Additionally, processor 32 can direct video switch 30 to select an appropriate one of the cameras, C1 . . . Cn associated with an active one of the receivers 14-i.

The real time video from the selected camera can then also be presented on the display 40 to provide to any first responder equipped with a display, a view of that portion of the region where the active RFID tag has been sensed. The display on the unit 40 can provide to the first responder immediate feedback as to the circumstances and activities of the individual I whose RFID tag 20 has triggered the display.

As the individual(s) I moves across the floor plan F, the RFID tag 20 will be activated by different transmitters and its reply sensed by different receivers. For example, initially the RFID tag of individual 20 would be sensed by a receiver in unit 14-k. As the individual I moves across the floor plan F, and comes within range of transmitter/receiver unit 14-i, the RFID tag 20 would transmit signals 22b to the associated receiver which would then be coupled to processor 32. Processor 32 could in response thereto direct video switch 30 to switch from camera Cn to camera C1 thereby providing real time video of the updated location and circumstances of the individual I.

Those of skill in the art will recognize that the video on display 40 could overlay a plan view, such as the view of FIG. 1. Alternately, it could be presented adjacent to a plan view as illustrated in FIG. 2. FIG. 1 thus is a representation of an exemplary portion F of a region being monitored which illustrates various components of system 10. It is also a representation of a image of region F which could be presented on display 40.

It will be understood that the image of FIG. 1 is but one of a plurality of images corresponding to various aspects of a region such as floor F1, F2 . . . Fn which could be stored in the database 36 and retrieved as need for presentation on the display 40.

The processor 32 could also be in communication with a regional monitoring system 50 which might be a local fire alarm system or any other building system. The system 50 could include a plurality of detectors 52 scattered throughout the floors F, F1 . . . Fn of the region being monitored. Information could simultaneously be presented on display 40 as to members of the plurality 52 which have gone into alarm.

It will be understood that the above description relating to RFID tags is exemplary only. Various types of RFID tags could be associated with first responders or other emergency personnel without departing from the spirit and scope of the invention. Further, regions can be saturated with RF from a common transmitter. In this embodiment, receivers are installed as in FIG. 1 and respond to signals such as 22a, b from one or more activated RFID tags.

It will also be understood that non-human assets such as livestock or equipment could also be tagged, tracked and displayed to assist first responders in finding or making determinations as to various assets. Further, displayable information from various cameras or pre-stored location views, from the database(s), illustrating the location or presence of activated tags can be provided not only to command personnel but also to responders in the field via portable displays.

From the foregoing, it will be observed that numerous variations and modifications may be effected without departing from the spirit and scope of the invention. It is to be understood that no limitation with respect to the specific apparatus illustrated herein is intended or should be inferred. It is, of course, intended to cover by the appended claims all such modifications as fall within the scope of the claims.

What is claimed:

1. A system comprising:
a plurality of wireless signal sensors;
a plurality of video cameras;
circuitry for combining signals from various of the sensors with signals from at least one of the video cameras to thereby present a visual display.

2. A system as in claim 1 which includes circuitry to select signals from at least one camera in response to a predefined sensor signal.

3. A system as in claim 1 which includes a plurality of wireless signal identification modules.

4. A system as in claim 1 where the wireless signals comprise radio frequency sign als.

5. A system as in claim 2 where the wireless signals comprise radio frequency signals.

6. A system as in claim 5 which includes a plurality of wireless signal identification modules.

7. A system as in claim 6 which includes a display device coupled to the combining circuitry, the device presenting a display of a region where at least one of the sensors has emitted the predefined sensor signal in response to sensing at least one of the identification modules.

8. A system as in claim 7 which includes a plurality of pre-stored, displayable regions.

9. A system as in claim 8 which includes circuitry to select a region for display.

10. A system as in claim 8 where the displayable region is selected in response to at least one received wireless signal.

11. A system as in claim 10 where the region is selected in part in response to a signal from at least one video camera.

12. A system as in claim 7 where the display device combines the region with a display associated with signals from one of the video cameras.

13. A system as in claim 12 which includes circuitry to select one of a group of cameras.

14. A system as in claim 12 which includes a database of a plurality of regions.

15. A method comprising:
establishing a plurality of electronic representations of a plurality of regions;
sensing a wireless signal emanating from within one of the regions;
combining a real-time image of the vicinity of the origin of the sensed signal from the one region with an electronic representation of the one region; and
presenting a visual representation thereof.

16. A method as in claim 15 which includes providing at least one source of wireless signals in at least some of the regions.

17. A method as in claim 15 which includes generating real-time images of portions of the regions.

18. A method as in claim 17 which includes selecting a real-time image based on the sensed wireless signal.

19. A method as in claim 18 which includes injecting a plurality of mobile sources of wireless signals into at least one of the regions.

20. A method as in claim 19 which includes displaying identification indicia associated with a sensed wireless signal from one of the sources.

21. A method as in claim 19 which includes associating mobile sources with respective first responders.

22. Software recorded on a computer readable medium comprising:
first software for sensing signals from a plurality of wireless sensors;
second software, responsive to sensed wireless signals, for selecting a region to be displayed; and
third software to present images associated with at least one sensor in conjunction with a representation of the selected region.

23. Software as in claim 22 for presenting visual identifiers of sources of wireless signals.

24. Software as in claim 22 for storing and retrieving a plurality of regional representations.

25. Software as in claim 22 for selecting a source of the images to be overlaid on the representation of the region.

26. A system comprising:
a plurality of cameras;
a plurality of radio frequency receivers;
a switch for selecting a camera from the plurality;
a database which contains at least, a pre-stored set of representations, each representation illustrating an aspect of a region being monitored; and
control software coupled to the sensors, the switch and the database to select a diagram and a camera in response to signals from at least one sensor.

27. A system as in claim 26 which includes additional software to visually display the selected diagram as well as images from the selected camera.

28. A system as in claim 26 which includes at least one radio frequency transmitter.

29. A system as in claim 26 where transmitters are associated with at least some of the receivers.
